(19) United States
(12) Patent Application Publication
(10) Pub. No.: US 2013/0094623 A1
(43) Pub. Date: Apr. 18, 2013

(54) SAFETY/RELIEF VALVE DISCHARGE LINE HEADER IN A BOILING WATER REACTOR

(71) Applicants: JIN-SEN CHUNG, Taoyuan County (TW); Shih-Jen Wang, Taoyuan County (TW); Ying-Ruei Yuann, Taoyuan County (TW)

(72) Inventors: JIN-SEN CHUNG, Taoyuan County (TW); Shih-Jen Wang, Taoyuan County (TW); Ying-Ruei Yuann, Taoyuan County (TW)

(73) Assignee: Institute of Nuclear Energy Research Atomic Energy Council, Executive Yuan, Taoyuan County (TW)

(21) Appl. No.: 13/329,678

(22) Filed: Dec. 19, 2011

(30) Foreign Application Priority Data
Oct. 18, 2011 (TW) 100219508

(51) Int. Cl. G21C 9/004

(52) U.S. Cl. 376/283

(57) ABSTRACT

To install a safety/relief valve(S/RV) discharge line header in addition, on a current S/RV discharge lines in a BWR, can provide a steam release path to many quencher devices. Then the steam blowdown during the S/RV discharge can be more even or symmetrically distributed into the suppression pool in a BWR. The S/RV discharge line header is installed at the middle sections of either all or a portion of S/RV discharge pipes. A current S/RV discharge pipe is installed with a S/RV and a vacuum breaker and its discharge tailpipe is welded with the end of a quencher device inlet. The proposed discharge lines include components such as reactor safety/relief valves, discharge pipes, vacuum breakers, a discharge line header, quencher devices, etc.

### FIELD OF THE INVENTION

The present invention relates to a pathway for allowing a flow of steam to be discharged evenly to a suppression pool after passing through safety/relief valves, discharge pipes, a discharge line header, and quencher devices in a boiling water reactor (BWR). More particularly, a safety/relief valve discharge line header is installed to connect to safety/relief valve discharge pipes and a plurality of quencher devices via lower discharge pipes.

### BACKGROUND OF THE INVENTION

Containment, which is a steel or reinforced concrete structure enclosing a nuclear reactor, usually is consisted of a drywell, a supression pool and a wetwell. The suppression pool is used to remove steam released through the discharging of safety/relief valves, if an event occurrence in which large quantities of steam are released from the reactor, and thereby can be used for containing the escape of radiation while enabling the pressure inside the containment to be maintained within a safe range. There are series of GE production BWRs evolved throughout the years, such as BWR/4, BWR/6, and Advanced Boiling Water Rector (ABWR), and consequently there are different containment designs, referred to by the names Mark I, Mark II, Mark III, and ABWR containment. Nevertheless, the safety/relief valve discharge line piping as well as its corresponding containment design must conform to the requirements specified in the General Design Criteria (GDCs) in Appendix A to 10 CFR. Part 50 by United States Nuclear Regulatory Commission and also the requirements related to Final Safety Analysis Report (FSAR) for a nuclear power plant, and so on. Accordingly, the releasing of steam through the safety/relief valves into the suppression pool is strictly defined in view of the temperature of the pool water and the charging exerted upon the quencher devices. However, after the discharging of steam through the open safety/relief valves and into the suppression pool, this can cause the temperature of the water in the suppression pool to be distributed very uneven between the locations where there are flows of steam charging into the pool and other locations where there are none.

Generally, there can be about sixteen or even eighteen safety/relief valves being installed in each BWR. Operationally, if the steam released from the safety/relief valve, it is carried into the suppression pool water after being guided through the discharge piping and the submerged quencher devices for cooling the steam, and thus condensed back into water. It is noted that the plural quencher devices are distributed 360 degrees around the bottom of the suppression pool. For instance, there can be eighteen quencher devices used in an ABWR, in a manner that they are equiangularly distributed around the periphery of a suppression pool of its containment, i.e. any two neighboring quencher devices are spaced from each other by about 18 degrees while allowing one of the two to be disposed on an inner ring and the other to be disposed on an out ring in an alternating manner, as the quencher devices 361, 362, 363, 364, 365, 366, 367, 368, 369, disposed on the first ring 381 and the second ring 382 shown in FIG. 1.

Please refer to FIG. 2, which is a line diagram showing a conventional safety/relief valve discharge line in a BWR with single circuit design. As shown in FIG. 2, there is a discharge pipe 19 that is independently disposed and is connected to one single safety/relief valve 12 by one end thereof and to a quencher device 15 by another end, as the quencher device is submerged under the water surface of a suppression pool 14. With the foregoing design, in an nuclear crisis of primary main steam isolation valves failure close and loosing thermal removal ability, the water temperature in the area of the suppression pool 14 that is proximate to the single quencher device 15 will increase more rapidly than the other areas.

According to the technical report NUREG/CR-5978 from United States Nuclear Regulatory Commission, under the crisis, the nuclides, such as radioactive iodine that is released from the reactor vessel via the safety/relief valve during nuclear meltdown, can be trapped and contained in a pool of water with sufficient subcooling and also deep enough. Notably, with decreasing subcooling, the ability of the pool for trapping nuclides will decrease accordingly. Under saturated water temperature, the amount of nuclides that is retained in the pool water is well under 90% of the nuclides flowing into the pool. Therefore, in a crisis of nuclear meltdown, the use of a conventional BWR design, being configured for enabling each discharge pipe to be connected to one single safety/relief valve for discharging a flow of steam into the suppression pool through a single quencher device, is not capable of retaining nuclides effectively for nuclear decontamination, which is especially true in an event of nuclear power plant blackouts with loss of thermal removal ability from beginning and emergency core cooling system (ECCS) failure late, or in an event of the anticipated transient without scram (ATWS) with ECCS failure late.

### SUMMARY OF THE INVENTION

The object of the present invention is to provide a flow pathway for safety/relief valve discharge in a BWR, capable of dividing and diverting steam flows discharged from safety/relief valves to flow passing a plurality of quencher devices in a suppression pool so as to enable the steam flows to be distributed even while being condensed into water in the suppression pool, as shown in FIG. 3, and thus improves the performance of the suppression pool. The function of the invention design does not exist in the conventional safety/relief valve discharge pathway design in the BWRs, as shown in FIG. 2, to discharge the steam into the suppression pool for condensation effectiveness after a successive-steam-discharge-to-suppression-pool period.

In an embodiment of the invention, there are vacuum breakers being arranged in the piping layout, in a manner that each of which is an attachment commonly placed on a discharge pipe at a position above the water surface of the suppression pool for preventing the discharge pipe from being nagatively pressurized and thus preventing water from being siphoned backward into the discharge pipe. That is, since it is certain to have some steam existing in the discharge pipe, after the discharging of steam from the safety/relief valves that travels passing the discharing pipe and then enters the suppression pool through the quencher device, and to have some steam being condesed back into water, the discharge pipe will become negatively pressurized after the safety/relief valve closure. Therefore, it is in need of a vacuum breaker to be attached to the discharge pipe for preventing the negative pressure from happening inside the discharge pipe.

In an embodiment of the invention, there are a plurality of quencher devices being arranged in the piping layout, in a manner that the plural quencher devices are arranged to be distributed as symmetrically as possible all over the bottom of the suppression pool while being coupled respectively to their corresponding discharge pipes with connection to the discharge line header so as to enable steam to be fed into the suppression pool more evenly and thus to be condensed into water effectively. It is noted that each of the plural quencher devices can be a “T”-shaped or an “X”-shaped device while each having a plurality of pores formed on the tube wall thereof to be used for jetting the steam into the suppression pool so as to stir up the pool water and thus improve the condensation of the steam.

In an embodiment of the invention, there are a plurality of discharge pipes with connection to the discharge line header at the middle sections thereof for enabling those discharge pipes to be in communication with one another. And each is connected to one safety/relief valve by one up end and one quencher device by another end. Then, the released steam can be guided and dispersed by the discharge line header to flow into those connected discharge pipes and then to their corresponding quencher devices and can discharge into the suppression pool for condensation.

In an embodiment of the invention, there is a discharge line header being arranged in the piping layout, which is substantially a larger sized pipe that is disposed and coupled to the discharge pipes about at the middle sections thereof. And thereby, when one safety/relief valve is open for releasing steam, the released steam after passing through the upper discharge pipe can be guided and dispersed by the discharge line header to flow into those lower discharge pipes and then to their corresponding quencher devices and can discharge into the suppression pool for condensation.

In an embodiment of the invention, there are main steam lines being arranged in the piping layout that are used for guiding the steam to flow to a steam turbine. Generally, an common BWR is designed with four main steam lines, and each of the four main steam lines is attached with at least one safety/relief valve for limiting the ultimate pressure reached in the corresponding main steam line so as to be used as over-pressure protection for the BWR. Moreover, for each main steam line, there are two main steam isolation valves attached thereto respectively at positions inside and outside the containment of the BWR for allowing isolate the primary system of the BWR according to the direction of a protection signal, to close each of the two main steam isolation valves.

In an embodiment, the piping layout of the invention comprises: a plurality of safety/relief valves 22, a plurality of discharge pipes 291, 292, 293, 294, 295, 296, a discharge line header 24, a plurality of vacuum breakers 23, and a plurality of quencher devices 25, as shown in FIG. 3. It is noted that the piping layout of the invention is characterized in that the discharge line header 24 is connected to the plural discharge pipes 291, 292, 293, 294, 295, 296.

Further scope of applicability of the present application will become more apparent from the detailed description given hereinafter. However, it should be understood that the detailed description and specific examples, while indicating preferred embodiments of the invention, are given by way of illustration only, so various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing how the “X”-shaped quencher devices are distributed all over the bottom of a suppression pool.

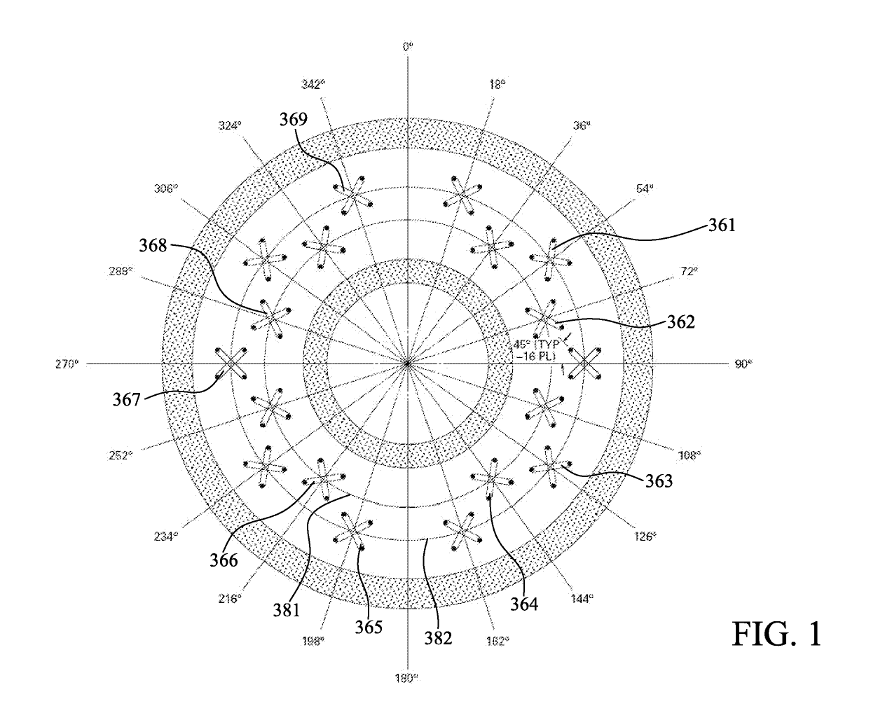

FIG. 2 is a line diagram showing a conventional safety/relief valve discharge line in a BWR with single circuit design.

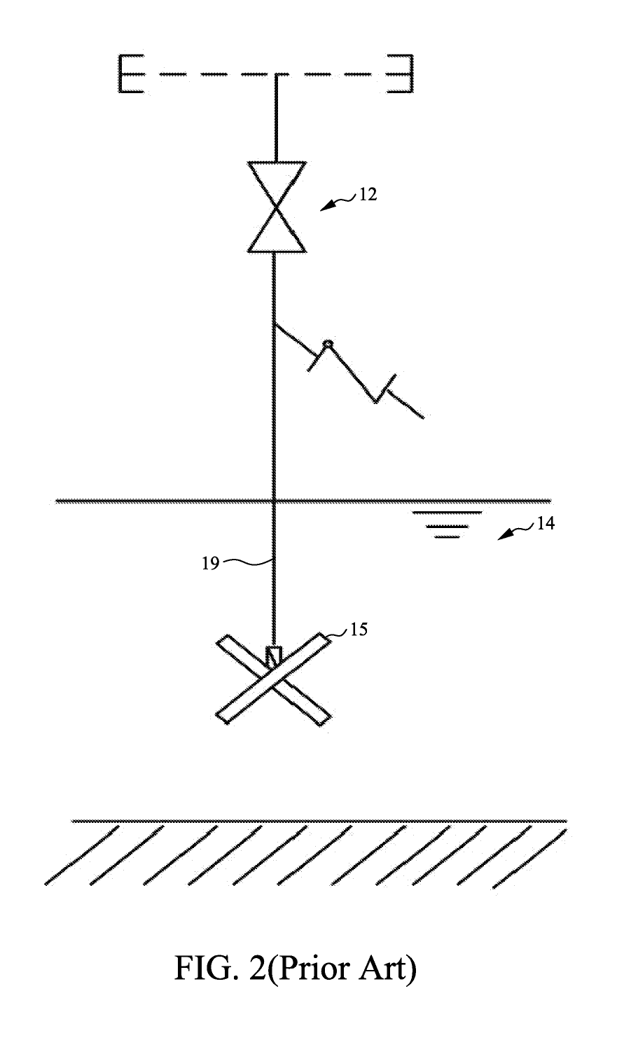

FIG. 3 is a line diagram showing a piping layout with a safety/relief valve discharge line header for BWRs according to the present invention.

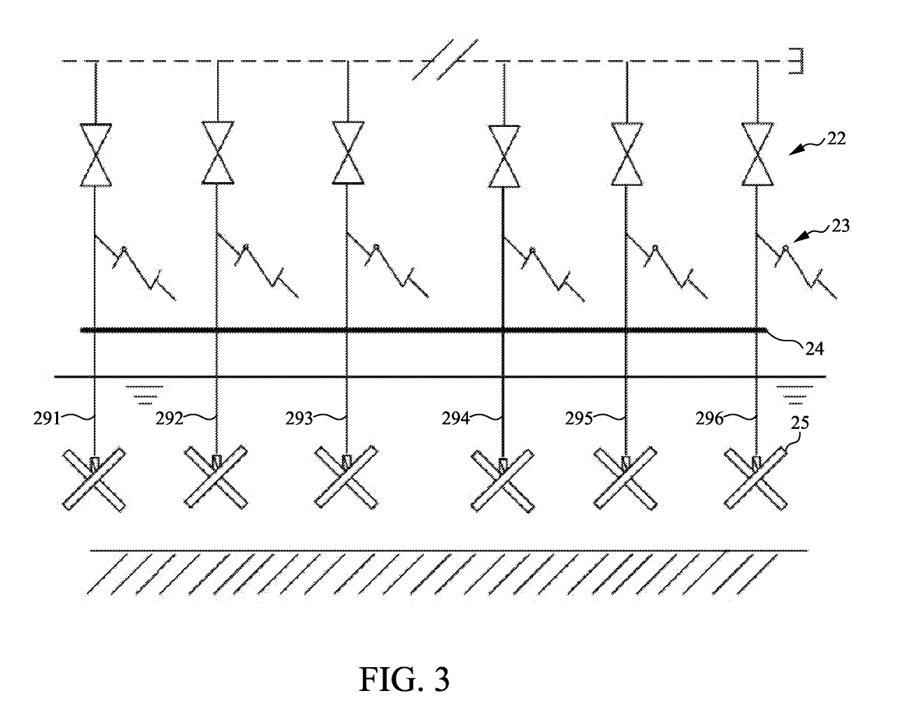

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

It is intended in the present invention to provide a piping layout for a safety/relief valve discharge line header in a BWR. That is capable of guiding a flow of steam discharged from an open safety/relief valve to a plurality of discharge pipes and quencher devices in the piping layout so as to limit to reach the containment ultimate pressure and the worse temperature of the pool water in the BWR.

The idea of the aforesaid piping layout for the discharge line header can be adapted for any BWR that is in construction or BWRs that are currently operating, so as to be used for improving the performance of the suppression pools in those BWRs.

The safety/relief valve discharge line piping layout of the invention as well as its corresponding containment design must conform to the requirements specified in the General Design Criteria (GDCs) in Appendix A to 10 CFR. Part 50 by United States Nuclear Regulatory Commission and also the requirements related to Final Safety Analysis Report (FSAR) for nuclear power plant, and so on.

Accordingly, the strength and the diameter of the pipes used in the piping layout of the invention and also the location of the discharge line header in the piping layout as well as the load factor of the discharge line header should be determined according to the amount of steam discharged from the safety/relief valves, the pressure of the discharged steam, and the steam flowing field designed in the piping layout. It is noted that by the addition of the discharge line header in the piping layout, the pressure of steam charging upon the quencher devices can be reduced. It is obviously that the dynamic load of piping layout of the present invention that is adapted for a primary system and containment integrity of a BWR must be also conformed to the above requirements.

In addition to the connecting of all the discharge pipes used in the piping layout of the invention by a discharge line header at the middle sections is thereof to enable all the discharge pipe to be in communication with one another. There can be another way for constructing the piping layout of the invention, as described in the following: a portion of the plural discharge pipes used as a conventional safety/relief valve discharge line in a BWR are independently disposed and each is connected to one safety/relief valve by one up end and one quencher device by another end; and the other portion of the plural discharge pipes are connected to one discharge line header at the middle sections thereof for enabling those discharge pipes to be in communication with one another, and each is connected to one safety/relief valve by one up end and one quencher device by another end. While enabling the connected safety/relief valve to open at a comparatively lower predetermined set pressure, the flow pathway in the present invention provides a flow guide and dispersion by the discharge line header to flow into those connected discharge pipes and then to their corresponding quencher devices for the released steam discharging even into the suppression pool for condensation.

With respect to the above description then, it is to be realized that the optimum dimension relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A piping layout for guiding steam of a boiling water reactor (BWR) into a suppression pool thereof for condensation, comprising:
at least one main steam line, for the steam supply of the BWR;
at least two safety/relief valves, connected to the main steam line;
at least two vacuum breakers, each connected to its corresponding safety/relief valve discharge pipe;
at least two discharge pipes, each connected to its corresponding safety/relief valve by one end thereof for allowing the steam to flow therein;
a discharge line header, connected to at least two upper discharge pipes for enabling the steam of the BWR to be dispersed and flow into each of the at least two lower discharge pipes; and
at least two quencher devices, each connected to its corresponding lower discharge pipe for further dispersing and discharging the steam into the suppression pool for condensation.

2. The piping layout of claim 1, wherein the discharge line header is arranged for allowing the steam flowing therein to be in communication with each of the at least two lower discharge pipes, thus enabling the steam to be discharged into the suppression pool evenly or symmetrically so as to be condensed more effectively.

3. The piping layout of claim 1, wherein each of at least two vacuum breaker is an attachment commonly placed on one corresponding discharge pipe for preventing the discharge pipe from being nagatively pressurized and thus preventing water in the suppression pool from being siphoned backward into the discharge pipe.

4. The piping layout of claim 1, wherein each of at least two quencher devices is used for enabling the steam to be jetted into the suppression pool evenly or symmetrically and thus to be condensed into water effectively, as the steam is received from its corresponding discharge pipe and safety/relief valve; and each of the at least two quencher devices is a “T”-shaped or an “X”-shaped tube.

5. The piping layout of claim 1, wherein each of at least two discharge pipes is used for guiding the steam to travel therein and is arranged in the piping layout in a manner that each of which is connected to one corresponding safety/relief valve.

6. The piping layout of claim 1, wherein each of at least one main steam line is used for guiding the steam to flow to a steam turbine, and each of which is configured with two main steam isolation valves respectively at positions inside and outside a containment of the BWR for isolating a primary system of the BWR, and thus enabling each of the two main steam isolation valves to be closed, according to the direction of a protection signal.

7. The piping layout of claim 1, wherein the discharge line header is disposed and coupled to all or the at least two discharge lines about at the middle sections thereof, and thereby as each of the at least two discharge lines is connected to its corresponding safety/relief valve, and simultaneously all or the at least two discharge pipes are connected to its corresponding quencher devices while enabling the quencher device to be submerged in the suppression pool.

8. The piping layout of claim 1, wherein there are a plurality of discharge pipes being arranged in the piping layout, in a manner that a portion of the plural discharge pipes are independently disposed and each is connected to one safety/relief valve by one up end and one quencher device by another end; and the other portion of the plural discharge pipes are connected to one discharge line header at the middle sections thereof for enabling those discharge pipes to be in communication with one another, and each is connected to one safety/relief valve by one up end and one quencher device by another end while enabling the connected safety/relief valve to open at a comparatively lower predetermined set pressure and enabling the quencher devices to submerge in the suppression pool.
